(19) United States
(12) Patent Application Publication
(10) Pub. No.: US 2026/0252253 A1
(43) Pub. Date: Aug. 27, 2026

(54) Reducing Amount of mSets Loading and Performing Data Rebuild During Host Data Relocation

(71) Applicant: Sandisk Technologies, Inc., Milpitas, CA (US)

(72) Inventors: Igor GENSHAFT, Bat Yam (IL); Vered KELNER, Gan Haim, IL (US); Marina FRID, Jerusalem (IL)

(73) Assignee: Sandisk Technologies, Inc., Milpitas, CA (US)

(21) Appl. No.: 19/062,357

(22) Filed: Feb. 25, 2025

(51) Int. Cl. G06F 3/06

(52) U.S. Cl. CPC G06F 3/0647; G06F 3/0619; G06F 3/0659; G06F 3/0679

(57) ABSTRACT

Data relocation or rebuild can be accomplished much more efficiently by using either a metadata option or an mSet option. The metadata option involves scanning metadata in a source block to find logical block addresses (LBAs) that belong to a particular mSet. Thereafter, all of the data for any found LBAs for the particular mSet are copied to the destination block one after another. The mSet option involves bringing the mSet related to one of the LBAs found in the metadata to a specific storage location, such as random access memory (RAM), and then scanning the mSet to find any jumbo block addresses (JBAs) that belong to the source block. Thereafter, all of the data for the found JBAs are copied to the destination block one after another. Either option results in reducing the amount of mSet loading and ensures more efficient sequential reads.

### BACKGROUND OF THE DISCLOSURE

### Field of the Disclosure

Embodiments of the present disclosure generally relate to improving data relocation.

### DESCRIPTION OF THE RELATED ART

Storage devices use logical-to-physical (L2P) mapping and management tables with control data for dynamic mapping. The management tables are stored in flash memory (e.g., NAND), but in order to provide high performance management, copies are maintained in controller random access memory (RAM). Modern devices have dual-layered mapping architecture consisting of a Master Layer (mLayer) and an Update Layer (uLayer). The mLayer size is relatively big and the structure of the mLayer is regular (direct-access array). The uLayer size is much smaller and the structure of the uLayer is less regular. Mapping of the same logical block address (LBA) range can have a different size at different times. The mLayer can be easily divided into equal segments (mSets), which can be saved to flash and loaded from flash (i.e., swapped out and in) when needed.

Oftentimes, data is updated or even relocated within a data storage device. The relocation computation effort is high and is getting more complex with scattered data where the controller needs to gather the information, which flash management unit (FMU) is valid on not comparing header data of a block and mSet mapping data.

Currently, the scanning of the source block headers and the determining valid and invalid FMUs in units of mSet per FMU at a time occurs without taking into account the data distribution of the source block FMUs between the mSets. Hence different mSets may be uploaded and downloaded from and to the memory device (e.g., NAND) many times which adds significant delays to the computation and in addition the outcome destination block is not ordered according to the mSets.

Therefore, there is a need in the art for improved data relocation.

### SUMMARY OF THE DISCLOSURE

Data relocation or rebuild can be accomplished much more efficiently by using either a metadata option or an mSet option. The metadata option involves scanning metadata in a source block to find logical block addresses (LBAs) that belong to a particular mSet. Thereafter, all of the data for any found LBAs for the particular mSet are copied to the destination block one after another. The mSet option involves bringing the mSet related to one of the LBAs found in the metadata to a specific storage location, such as random access memory (RAM), and then scanning the mSet to find any jumbo block addresses (JBAs) that belong to the source block. Thereafter, all of the data for the found JBAs are copied to the destination block one after another. Either option results in reducing the amount of mSet loading and ensures more efficient sequential reads.

In one embodiment, a data storage device comprises: a memory device; and a controller coupled to the memory device, wherein the controller is configured to: scan metadata in a source block for logical block addresses (LBAs) that belong to a same mSet; and copy data corresponding to the LBAs that belong to the same mSet from the source block to a destination block.

In another embodiment, a data storage device comprises: a memory device; and a controller coupled to the memory device, wherein the controller is configured to: scan mSets for jumbo block addresses (JBAs) or flash management units (FMUs) that belong to a source block; and copy data for matching JBAs or FMUs to a destination block.

In another embodiment, a data storage device comprises: means to store data; and a controller coupled to the means to store data, wherein the controller is configured to: determine to perform a data rebuild operation; scan metadata in a source block; determine whether a workload is a narrow workload or a wide workload; and copy valid data from the source block to a destination block.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a schematic block diagram illustrating a storage system in which a data storage device may function as a storage device for a host device, according to certain embodiments.

FIG. 2 is a schematic illustration of data relocation according to one embodiment.

FIG. 3 is a schematic illustration of a memory device (e.g., NAND) block structure according to one embodiment.

FIG. 4 is a schematic illustration of a block for read metadata and validation according to one embodiment.

FIG. 5 is a schematic illustration of copying valid data from a source block to a destination block according to one embodiment.

FIG. 6 is a flowchart illustrating copying valid data from a source block to a destination block according to one embodiment.

FIG. 7 is a schematic illustration of data relocation with data rebuild according to one embodiment.

FIG. 8 is a flowchart illustrating data relocation with data rebuild according to one embodiment.

FIG. 9 is a schematic illustration of a data rebuild via metadata according to one embodiment.

FIG. 10 is a flowchart illustrating data rebuild via metadata according to one embodiment.

FIG. 11 is a schematic illustration of a data rebuild via mSet according to one embodiment.

FIG. 12 is a flowchart illustrating a data rebuild via mSet according to one embodiment.

FIG. 13 is a flowchart illustrating a data rebuild via metadata or mSet according to one embodiment.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

In the following, reference is made to embodiments of the disclosure. However, it should be understood that the disclosure is not limited to specifically described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments, and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

Data relocation or rebuild can be accomplished much more efficiently by using either a metadata option or an mSet option. The metadata option involves scanning metadata in a source block to find logical block addresses (LBAs) that belong to a particular mSet. Thereafter, all of the data for any found LBAs for the particular mSet are copied to the destination block one after another. The mSet option involves bringing the mSet related to one of the LBAs found in the metadata to a specific storage location, such as random access memory (RAM), and then scanning the mSet to find any jumbo block addresses (JBAs) that belong to the source block. Thereafter, all of the data for the found JBAs are copied to the destination block one after another. Either option results in reducing the amount of mSet loading and ensures more efficient sequential reads.

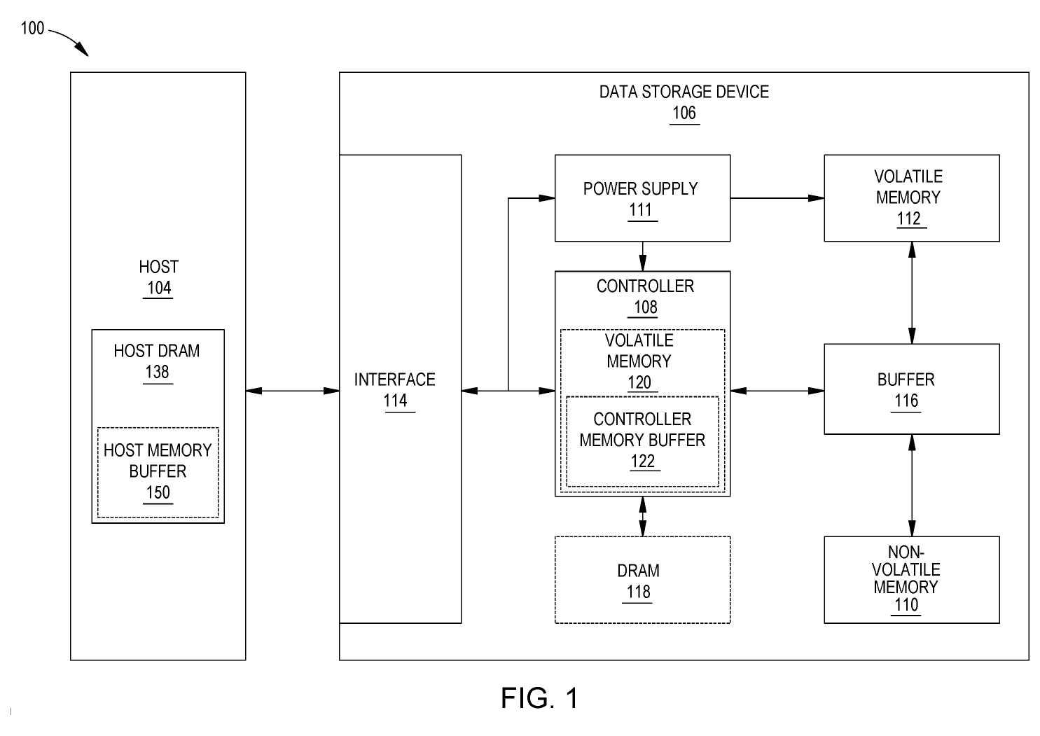

FIG. 1 is a schematic block diagram illustrating a storage system 100 having a data storage device 106 that may function as a storage device for a host device 104, according to certain embodiments. For instance, the host device 104 may utilize a non-volatile memory (NVM) 110 included in data storage device 106 to store and retrieve data. The host device 104 comprises a host dynamic random access memory (DRAM) 138. In some examples, the storage system 100 may include a plurality of storage devices, such as the data storage device 106, which may operate as a storage array. For instance, the storage system 100 may include a plurality of data storage devices 106 configured as a redundant array of inexpensive/independent disks (RAID) that collectively function as a mass storage device for the host device 104.

The host device 104 may store and/or retrieve data to and/or from one or more storage devices, such as the data storage device 106. As illustrated in FIG. 1, the host device 104 may communicate with the data storage device 106 via an interface 114. The host device 104 may comprise any of a wide range of devices, including computer servers, network-attached storage (NAS) units, desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or other devices capable of sending or receiving data from a data storage device.

The host DRAM 138 may optionally include a host memory buffer (HMB) 150. The HMB 150 is a portion of the host DRAM 138 that is allocated to the data storage device 106 for exclusive use by a controller 108 of the data storage device 106. For example, the controller 108 may store mapping data, buffered commands, logical to physical (L2P) tables, metadata, and the like in the HMB 150. In other words, the HMB 150 may be used by the controller 108 to store data that would normally be stored in a volatile memory 112, a buffer 116, an internal memory of the controller 108, such as static random access memory (SRAM), and the like. In examples where the data storage device 106 does not include a DRAM (i.e., optional DRAM 118), the controller 108 may utilize the HMB 150 as the DRAM of the data storage device 106.

The data storage device 106 includes the controller 108, NVM 110, a power supply 111, volatile memory 112, the interface 114, a write buffer 116, and an optional DRAM 118. In some examples, the data storage device 106 may include additional components not shown in FIG. 1 for the sake of clarity. For example, the data storage device 106 may include a printed circuit board (PCB) to which components of the data storage device 106 are mechanically attached and which includes electrically conductive traces that electrically interconnect components of the data storage device 106 or the like. In some examples, the physical dimensions and connector configurations of the data storage device 106 may conform to one or more standard form factors. Some example standard form factors include, but are not limited to, 3.5” data storage device (e.g., an HDD or SSD), 2.5” data storage device, 1.8” data storage device, peripheral component interconnect (PCI), PCI-extended (PCI-X), PCI Express (PCIe) (e.g., PCIe x1, x4, x8, x16, PCIe Mini Card, MiniPCI, etc.). In some examples, the data storage device 106 may be directly coupled (e.g., directly soldered or plugged into a connector) to a motherboard of the host device 104.

Interface 114 may include one or both of a data bus for exchanging data with the host device 104 and a control bus for exchanging commands with the host device 104. Interface 114 may operate in accordance with any suitable protocol. For example, the interface 114 may operate in accordance with one or more of the following protocols: advanced technology attachment (ATA) (e.g., serial-ATA (SATA) and parallel-ATA (PATA)), Fibre Channel Protocol (FCP), small computer system interface (SCSI), serially attached SCSI (SAS), PCI, and PCIe, non-volatile memory express (NVMe), OpenCAPI, GenZ, Cache Coherent Interface Accelerator (CCIX), Open Channel SSD (OCSSD), or the like. Interface 114 (e.g., the data bus, the control bus, or both) is electrically connected to the controller 108, providing an electrical connection between the host device 104 and the controller 108, allowing data to be exchanged between the host device 104 and the controller 108. In some examples, the electrical connection of interface 114 may also permit the data storage device 106 to receive power from the host device 104. For example, as illustrated in FIG. 1, the power supply 111 may receive power from the host device 104 via interface 114.

The NVM 110 may include a plurality of memory devices or memory units. NVM 110 may be configured to store and/or retrieve data. For instance, a memory unit of NVM 110 may receive data and a message from controller 108 that instructs the memory unit to store the data. Similarly, the memory unit may receive a message from controller 108 that instructs the memory unit to retrieve data. In some examples, each of the memory units may be referred to as a die. In some examples, the NVM 110 may include a plurality of dies (i.e., a plurality of memory units). In some examples, each memory unit may be configured to store relatively large amounts of data (e.g., 128MB, 256MB, 512MB, 1GB, 2GB, 4GB, 8GB, 16GB, 32GB, 64GB, 128GB, 256GB, 512GB, 1TB, etc.).

In some examples, each memory unit may include any type of non-volatile memory devices, such as flash memory devices, phase-change memory (PCM) devices, resistive random-access memory (ReRAM) devices, magneto-resistive random-access memory (MRAM) devices, ferroelectric random-access memory (F-RAM), holographic memory devices, and any other type of non-volatile memory devices.

The NVM 110 may comprise a plurality of flash memory devices or memory units. NVM Flash memory devices may include NAND or NOR-based flash memory devices and may store data based on a charge contained in a floating gate of a transistor for each flash memory cell. In NVM flash memory devices, the flash memory device may be divided into a plurality of dies, where each die of the plurality of dies includes a plurality of physical or logical blocks, which may be further divided into a plurality of pages. Each block of the plurality of blocks within a particular memory device may include a plurality of NVM cells. Rows of NVM cells may be electrically connected using a word line to define a page of a plurality of pages. Respective cells in each of the plurality of pages may be electrically connected to respective bit lines. Furthermore, NVM flash memory devices may be 2D or 3D devices and may be single level cell (SLC), multi-level cell (MLC), triple level cell (TLC), or quad level cell (QLC). The controller 108 may write data to and read data from NVM flash memory devices at the page level and erase data from NVM flash memory devices at the block level.

The power supply 111 may provide power to one or more components of the data storage device 106. When operating in a standard mode, the power supply 111 may provide power to one or more components using power provided by an external device, such as the host device 104. For instance, the power supply 111 may provide power to the one or more components using power received from the host device 104 via interface 114. In some examples, the power supply 111 may include one or more power storage components configured to provide power to the one or more components when operating in a shutdown mode, such as where power ceases to be received from the external device. In this way, the power supply 111 may function as an onboard backup power source. Some examples of the one or more power storage components include, but are not limited to, capacitors, super-capacitors, batteries, and the like. In some examples, the amount of power that may be stored by the one or more power storage components may be a function of the cost and/or the size (e.g., area/volume) of the one or more power storage components. In other words, as the amount of power stored by the one or more power storage components increases, the cost and/or the size of the one or more power storage components also increases.

The volatile memory 112 may be used by controller 108 to store information. Volatile memory 112 may include one or more volatile memory devices. In some examples, controller 108 may use volatile memory 112 as a cache. For instance, controller 108 may store cached information in volatile memory 112 until the cached information is written to the NVM 110. As illustrated in FIG. 1, volatile memory 112 may consume power received from the power supply 111. Examples of volatile memory 112 include, but are not limited to, random-access memory (RAM), dynamic random access memory (DRAM), static RAM (SRAM), and synchronous dynamic RAM (SDRAM (e.g., DDR1, DDR2, DDR3, DDR3L, LPDDR3, DDR4, LPDDR4, and the like)). Likewise, the optional DRAM 118 may be utilized to store mapping data, buffered commands, logical to physical (L2P) tables, metadata, cached data, and the like in the optional DRAM 118. In some examples, the data storage device 106 does not include the optional DRAM 118, such that the data storage device 106 is DRAM-less. In other examples, the data storage device 106 includes the optional DRAM 118.

Controller 108 may manage one or more operations of the data storage device 106. For instance, controller 108 may manage the reading of data from and/or the writing of data to the NVM 110. In some embodiments, when the data storage device 106 receives a write command from the host device 104, the controller 108 may initiate a data storage command to store data to the NVM 110 and monitor the progress of the data storage command. Controller 108 may determine at least one operational characteristic of the storage system 100 and store at least one operational characteristic in the NVM 110. In some embodiments, when the data storage device 106 receives a write command from the host device 104, the controller 108 temporarily stores the data associated with the write command in the internal memory or write buffer 116 before sending the data to the NVM 110. Controller 108 may include circuitry or processors configured to execute programs for operating the data storage device 106.

The controller 108 may include an optional second volatile memory 120. The optional second volatile memory 120 may be similar to the volatile memory 112. For example, the optional second volatile memory 120 may be SRAM. The controller 108 may allocate a portion of the optional second volatile memory to the host device 104 as controller memory buffer (CMB) 122. The CMB 122 may be accessed directly by the host device 104. For example, rather than maintaining one or more submission queues in the host device 104, the host device 104 may utilize the CMB 122 to store the one or more submission queues normally maintained in the host device 104. In other words, the host device 104 may generate commands and store the generated commands, with or without the associated data, in the CMB 122, where the controller 108 accesses the CMB 122 in order to retrieve the stored generated commands and/or associated data.

As discussed herein, two relocation management methods are disclosed that may be implemented together or each alone that will improve the relocation or rebuild and will also provide a data rebuild in the destination block. The terms rebuild and relocation may be utilized interchangeably herein.

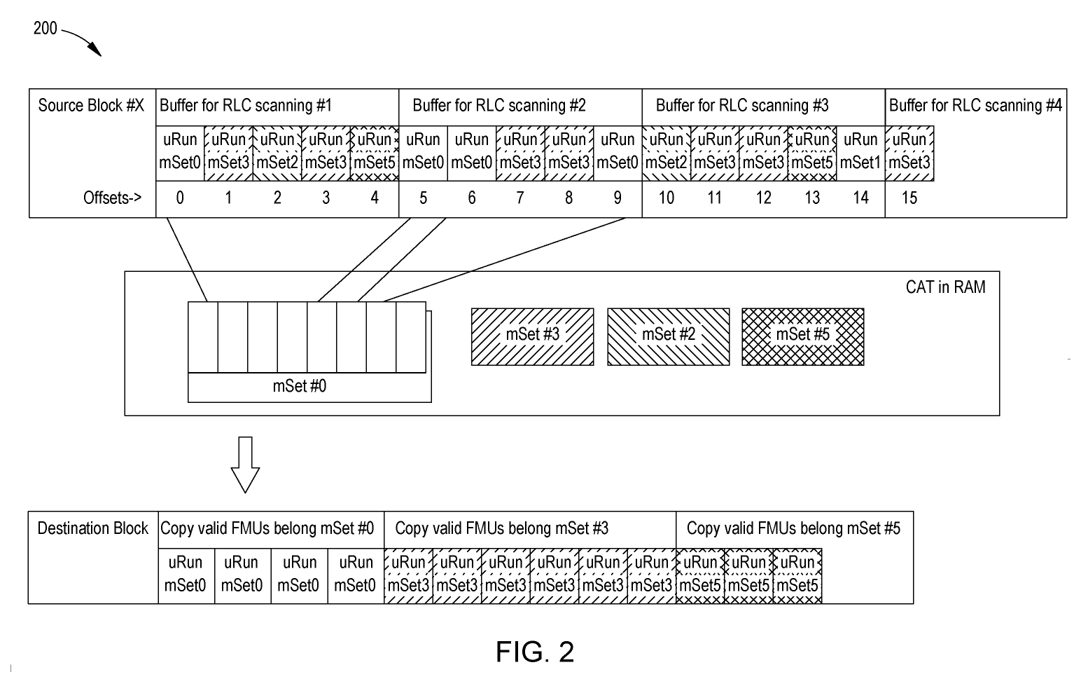

FIG. 2 is a schematic illustration 200 of data relocation according to one embodiment. As shown in FIG. 2, the source block contains numerous buffers (i.e., Buffer for relocation (RLC) scanning #1-4). Each buffer has numerous mSets containing a number of entries (uRun). Each mSet has an offset within the source block. The various uRuns are for specific mSets, which in the exemplified case are mSet 0, mSet 1, mSet 2, mSet 3, and mSet 5. The goal shown in FIG. 2 is for the uRuns in the mSets to be written to the destination block by copying valid FMUs to the destination block. To perform the relocation from the source block to the destination block, the uRuns belonging to common mSets are coupled together in computer assisted translation (CAT) table in random access memory (RAM) and then written to the destination block. As shown in FIG. 2, the uRuns for mSet 0 are all grouped together, and mSets 2, 3, and 5 are also arranged in the CAT table in RAM. The source block can be released once all mSets have been relocated. Ideally, the mSets will have the uRuns in sequential order in the destination block.

At a high level, the goal is to associate each FMU header in a scanned buffer of the source block to the mSets the FMU belongs to. Then, scan the mSets loaded to the CAT table for the sake of the relocation, look for other valid FMUs that belong to the same source block, and then copy all of the FMUs to the destination block. In this way, the mSets are loaded only once per source block. The alternative method goal is to search forward in the FMU headers in the scanned buffers and look if there are more FMUs that belong to the current mSet. Then all of the FMUs are validated against the mSet and copied to the destination block. Like the method mentioned above, the alternative method leads to a decrease of the number of times the same mSet needs to be loaded to the CAT table. Apart from reducing of the mSet loading amount, either of the methods will result in a data rebuild (i.e., in better grouping of the FMUs that belong to the same mSets) such that at next sequential read operations will be faster. In addition to either of the methods, the accumulated FMUs that belong to the same mSet may be sorted before writing them to the destination block which will gradually bring the FMUs in the destination block closer to their sequential order with each next relocation.

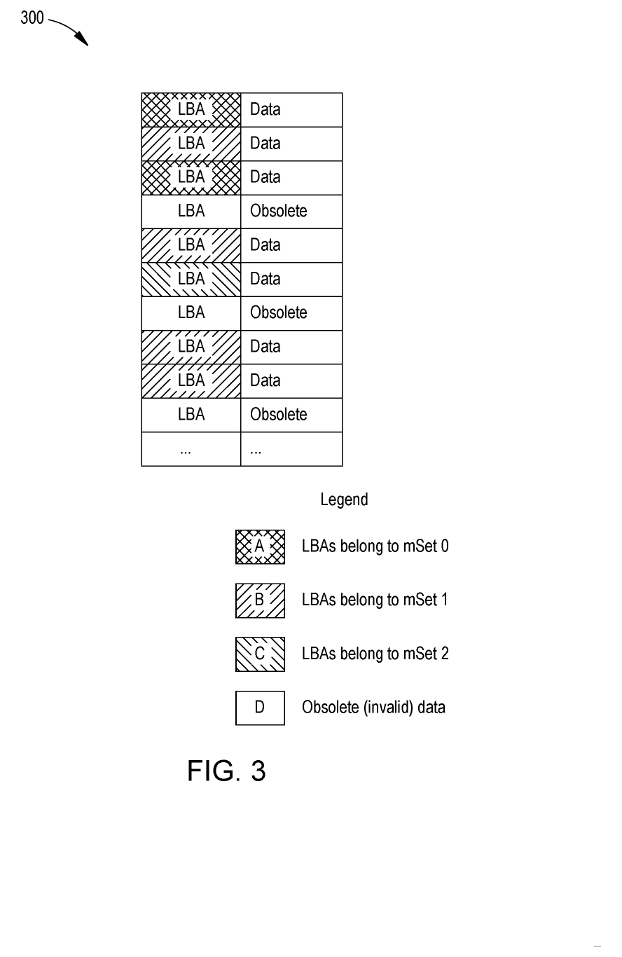

FIG. 3 is a schematic illustration 300 of a memory device (e.g., NAND) block structure according to one embodiment. The block structure includes a plurality of LBAs belonging to three different exemplified mSets (i.e., mSets 0-2) as well as obsolete mSets. Obsolete mSets contain invalid data. The block contains multiple FMUs or logical units and contains another connected part connected to the data that is called metadata. Metadata contains the logical block address (LBA) that is connected to the data written to the page. The LBAs that belong to mSet 0, mSet 1, mSet 2, and the obsolete mSets are marked accordingly. The obsolete LBAs are LBAs were written again and are now invalid.

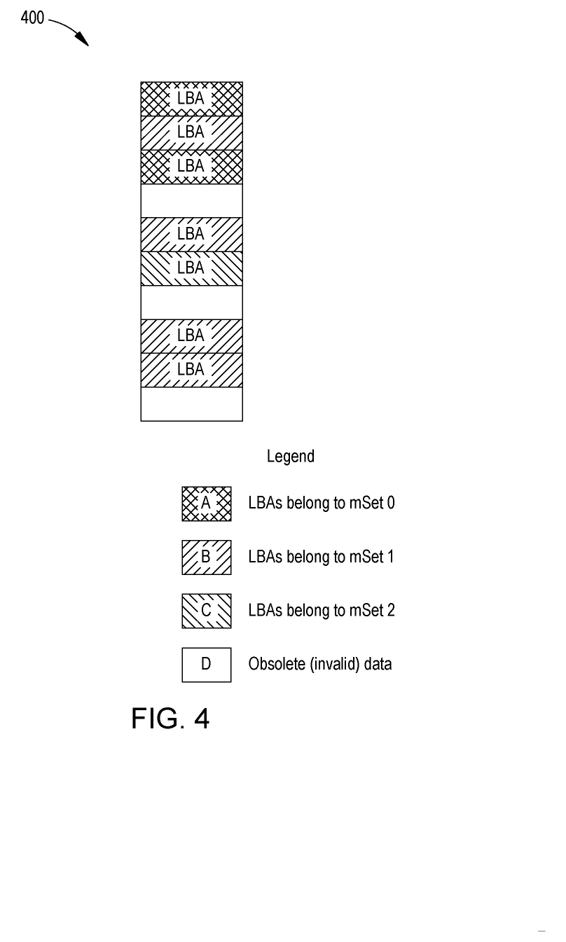

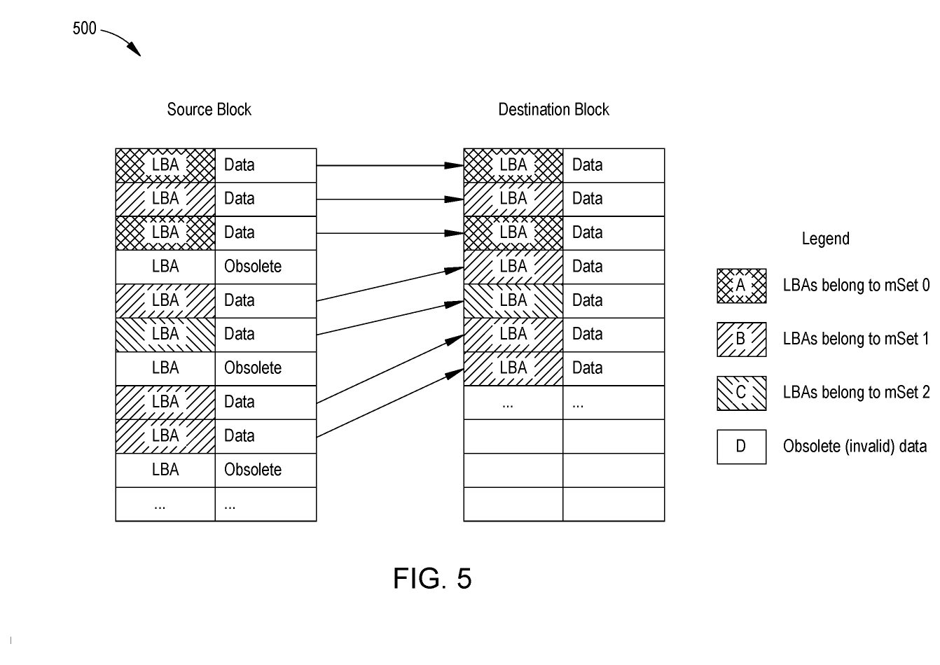

FIG. 4 is a schematic illustration of a block 400 for read metadata and validation according to one embodiment. FIG. 5 is a schematic illustration 500 of copying valid data from a source block to a destination block according to one embodiment. The metadata contains LBAs. In case there is no RAM space for metadata of the entire block, the metadata can be handled in portions. In portions meaning that the entire block is theoretically split into multiple, potentially equal portions with each portion is loaded to RAM, processed, and erased from RAM before another portion is loaded, processed, and erased.

First, the controller reads the metadata and makes the validation to separate the valid LBAs from the obsolete LBAs. The valid LBAs will be further copied from the source block such as shown in FIG. 5 which shows the source block and the metadata is related to the data. The obsolete LBAs will not be copied from the source block. The valid LBAs will be copied to the destination block. Because a memory block (e.g., NAND block) can contain a lot of pages, it may be the case that the RAM space is not capable of holding all the metadata of the block. In such a scenario, the metadata can be obtained in portions as a first part, second part, et cetera as noted above. When the metadata or a portion of the metadata is read and validated, the valid parts are copied through to the destination block. At the end of the copy, the source block can be released and the destination block contains all valid data taken from the source block.

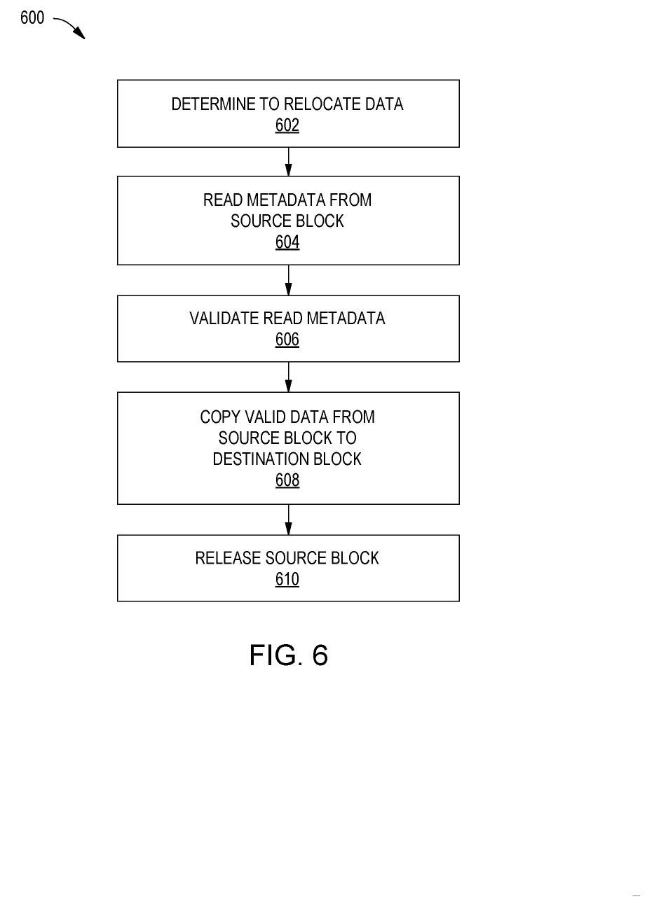

FIG. 6 is a flowchart 600 illustrating copying valid data from a source block to a destination block according to one embodiment. Initially, a determination is made at block 602 regarding relocating data. The determination can be made based upon any number of items such as command from a host device, garbage collection initiated by the controller, etc. Thereafter, metadata is read from the source block at block 604 followed by validation of the metadata at block 606. The valid data is then copied from the source block to the destination block at block 608, and then the source block is released at block 610.

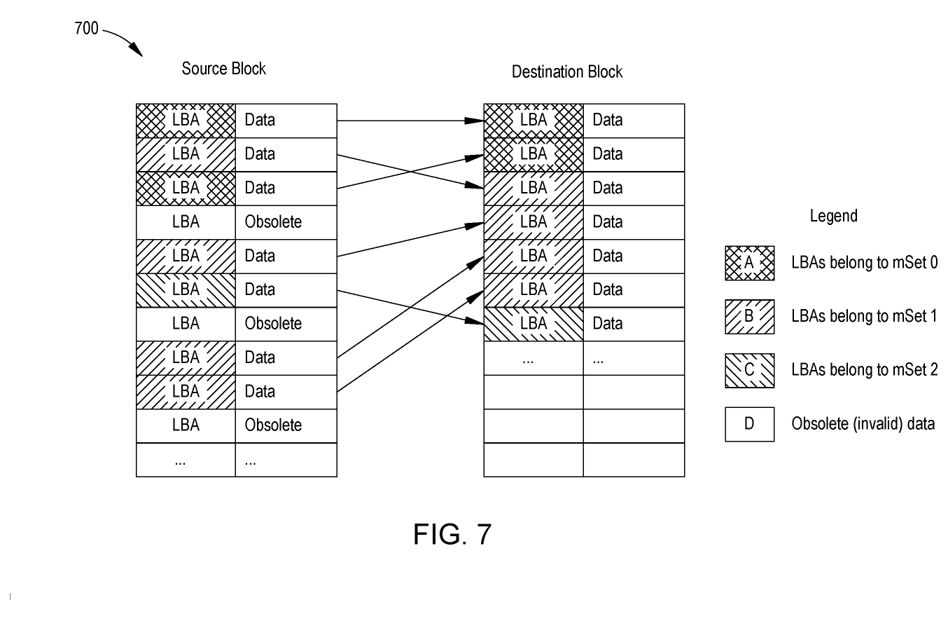

FIG. 7 is a schematic illustration 700 of data relocation with data rebuild according to one embodiment. The controller can group the data with LBAs close one to another into the destination block. Ideally, relocating the LBAs in the destination block would restore the continuity of the data so that the LBAs will be sequential. However, it is not always possible to obtain continuity of data during relocation. Therefore, at the very least, the controller can group the LBAs that are related to the same mSet together. In so doing, all the LBAs that relate to mSet 0 will be grouped together, all the LBAs for mSet 1 will be grouped together, etc.

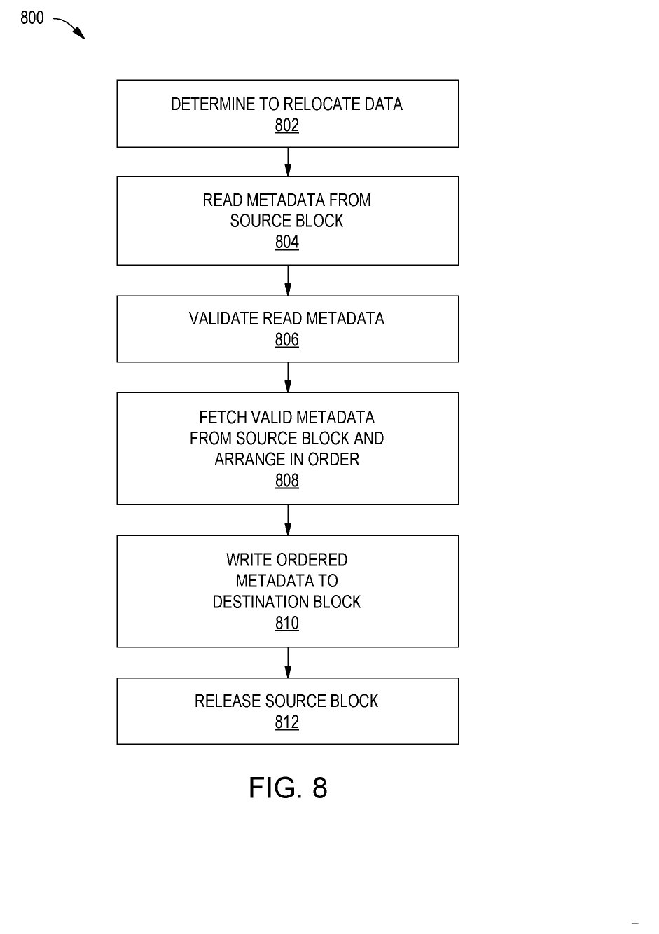

FIG. 8 is a flowchart 800 illustrating data relocation with data rebuild according to one embodiment. Initially, a determination is made at block 802 regarding relocating data. The determination can be made based upon any number of items such as command from a host device, garbage collection initiated by the controller, etc. Thereafter, metadata is read from the source block at block 804 followed by validation of the metadata at block 806. The valid data is then copied from the source block and arranged in, as best as possible, LBA sequential order and mSet grouping at block 808. The mSet grouping occurs, and the LBA order is as close as possible to be sequentially ordered. Thereafter, the ordered metadata is written to the destination block at block 810, and then the source block is released at block 812.

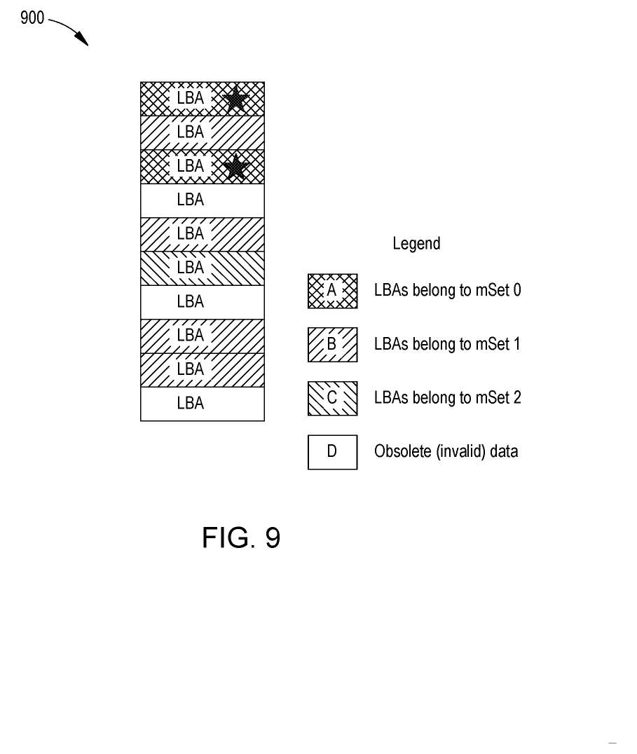

FIG. 9 is a schematic illustration 900 of a data rebuild via metadata according to one embodiment. As noted above, the disclosure describes two ways of data rebuild. The first way is by the metadata. Metadata is read for the validation and currently is used for the decision of which pages or which FMUs will be copied from the source block to the destination block. Before copying, the controller can scan the metadata, or a portion of the metadata if there is not enough RAM for the metadata of the entire block. The controller can scan the metadata and look for the LBAs that belong to the same mSet and copy LBAs that belong to the same mSet first. Then the controller can continue with another mSet and copy them all together, et cetera. Thus, for FIG. 9, the controller will scan the metadata in the source block for LBAs belonging to mSet 0 and then copy the valid metadata for mSet 0 to the destination block. The process will repeat for mSets 1 and 2.

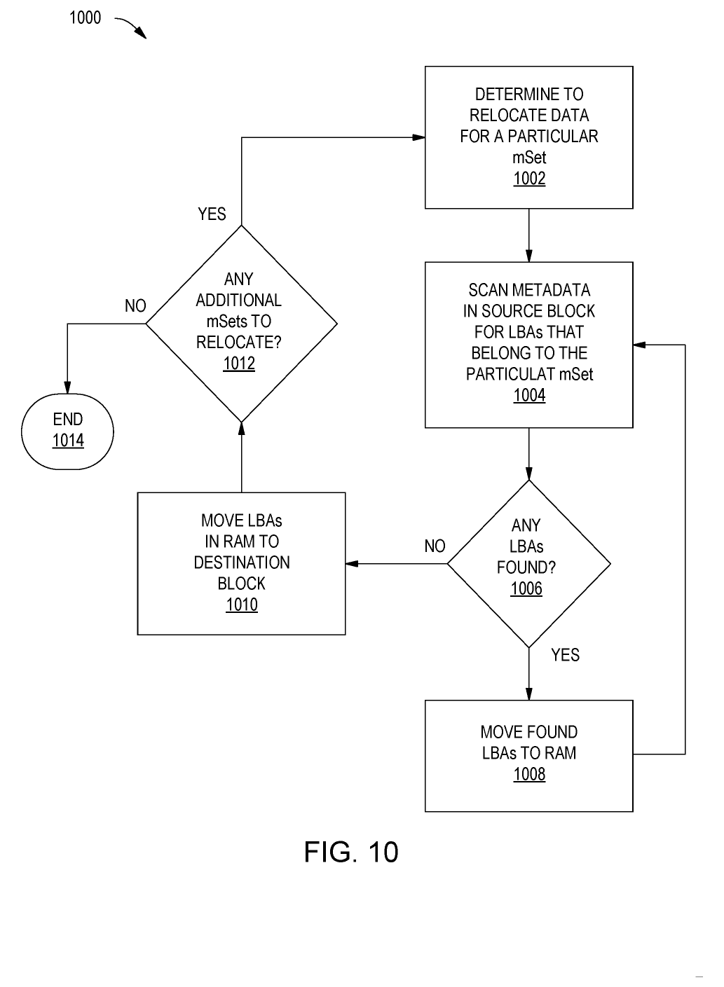

FIG. 10 is a flowchart 1000 illustrating data rebuild via metadata according to one embodiment. Initially, a determination is made regarding relocating data for a particular mSet at block 1002. The metadata is scanned at block 1004. The metadata is in the source block at the time of the scanning, and the scanning is for LBAs that belong to the particular mSet identified in block 1002. If any valid LBAs are found as determined at block 1006, then those LBAs are moved to a dedicated storage location, such as RAM, at block 1008 followed by repeating block 1004. If no valid LBAs are found at block 1006, then the process proceeds to block 1010 where the LBAs in the dedicated storage location, if any, are moved or copied to the destination block. Thereafter, a determination is made regarding whether there are any additional mSets to relocate at block 1012. If there are one or more additional mSets to relocate, then the process proceeds to block 1002, else the process ends at block 1014.

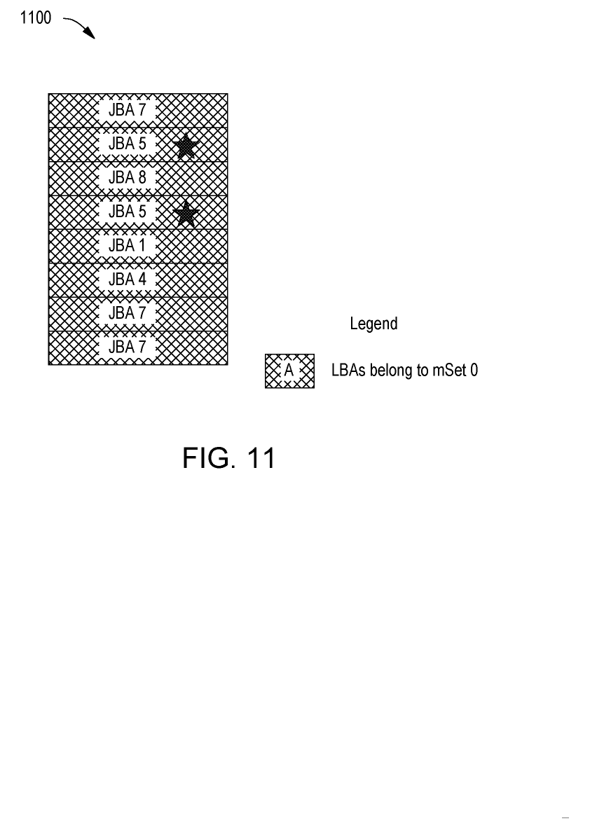

FIG. 11 is a schematic illustration 1100 of a data rebuild via mSet according to one embodiment. The second way to relocate data that is noted above is based on the scanning of the mSet. For instance, the mSet can be moved or copied to the dedicated storage location (i.e., RAM) for the validation purpose. The validation then occurs in the dedicated storage location. Without going into the technical details of how the validation works, the validation works faster when the mSet is in the dedicated storage location. However, even the mSet is not needed for the validation purpose, the controller can transfer the mSet to the dedicated storage location specifically for data review. When the mSet is in the dedicated storage location, the controller can scan the mSet and look for any jumbo block addresses (JBAs) that belong to the source block. For example, assume the source block is JBA 5. The controller can scan and find all the JBAs that belong to JBA 5 and copy those JBAs to the destination block. As shown in FIG. 11, there are JBAs and the JBA 5 points to the FMU that has to be copied so the controller can copy all the JBAs that have their block ID equal to the source block ID of the relocation. If the data rebuild is performed as such, then the destination block will have the LBAs taken for the mSet and sequential order, or at least very close to sequential order. After completing the relocation of JBA 5, then, if desired, the controller may proceed to relocate JBA 7 or some other JBA. It is contemplated that the controller may stop and JBA 5 and not proceed with any additional relocations at that point in time. It is contemplated that rather than JBAs, the process can utilize FMUs.

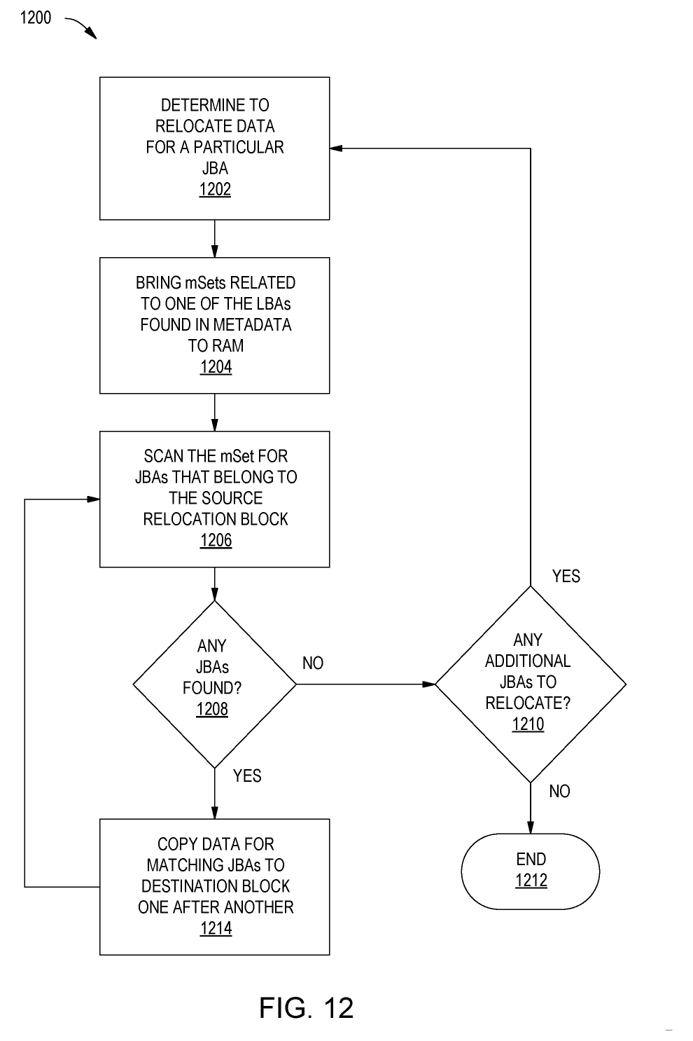

FIG. 12 is a flowchart 1200 illustrating a data rebuild via mSet according to one embodiment. Initially, a determination is made at block 1202 regarding relocating data from a source block to a destination block for a particular JBA. The mSets related to the LBAs found in metadata for the particular JBA are brought to a dedicated storage location (e.g., RAM) at block 1204 where the mSet is scanned for JBAs that belong to the source relocation block at block 1206. A determination is made at block 1208 regarding whether any JBAs are found. If there are no JBAs found, then a determination is made at block 1210 whether there are any additional JBAs to relocate. If there are JBAs to relocate, then the process returns to block 1202, but otherwise, the process ends at block 1212. If JBAs are found at block 1208, then data for matching JBAs are copied to the destination block one after another at block 1204 followed by repeating block 1206. It is contemplated that rather than JBAs, the process can utilize FMUs.

A source block may have multiple hundreds, thousands, or hundreds of thousands of FMUs. So if there is a big block, the controller needs to scan the metadata several times because the controller can't read all of the metadata of the block. In such a situation, it is better to use the mSet option because the controller can read mSets, read the metadata for the first FMU, and then to scan the mSet because the mSet is anywhere from ten to twelve times smaller than the block size. Thus, the controller can decide which way is better for the configuration...mSet option or metadata option. Stated another way, the controller is not using the metadata option and mSet option together, but rather, the controller is choosing which one to use based upon the current configuration. If the metadata option seems like the better option, the controller goes with the metadata option, otherwise, if the mSet option is the better option, the controller chooses to go that route.

For random writes with a very big range, any data rebuild is likely not efficient. Thus, for random writes, the controller needs to determine if in the randomly written block the controller can do something efficient. Thus, it may be better to try the metadata option to read metadata on a small portion. If there are several FMUs that belong to the same mSet, a determination is made regarding how many of the FMUs belong to the same mSet. If the controller determines that there are just one or two FMUs, for example, it is probably not efficient to perform a data rebuild (i.e., data relocation).

For a narrow workload, the LBAs in the entire block will belong to a predetermined, small amount of FMUs or there are many FMUs that belong to the same mSet. For a wide workload, a lot of mSets will be represented in the block and each mSet will have only a small amount of FMUs. For instance, the controller can start scanning the metadata and understand the distribution of the LBAs between the mSets. According to the distribution, the controller can decide whether to bring the mSet to the dedicated storage location (e.g., RAM) or not because bringing in the mSet to the dedicated storage location has a price: usage of the dedicated storage location, time for bringing the mSet to RAM, and other resources such as the memory device (e.g., NAND). Thus, bringing in the mSet to a dedicated storage location is a relatively expensive operation, so the controller may decide not to bring mSet if doing so will not be beneficial. In such a case, the controller can use the metadata option because the metadata has already been read.

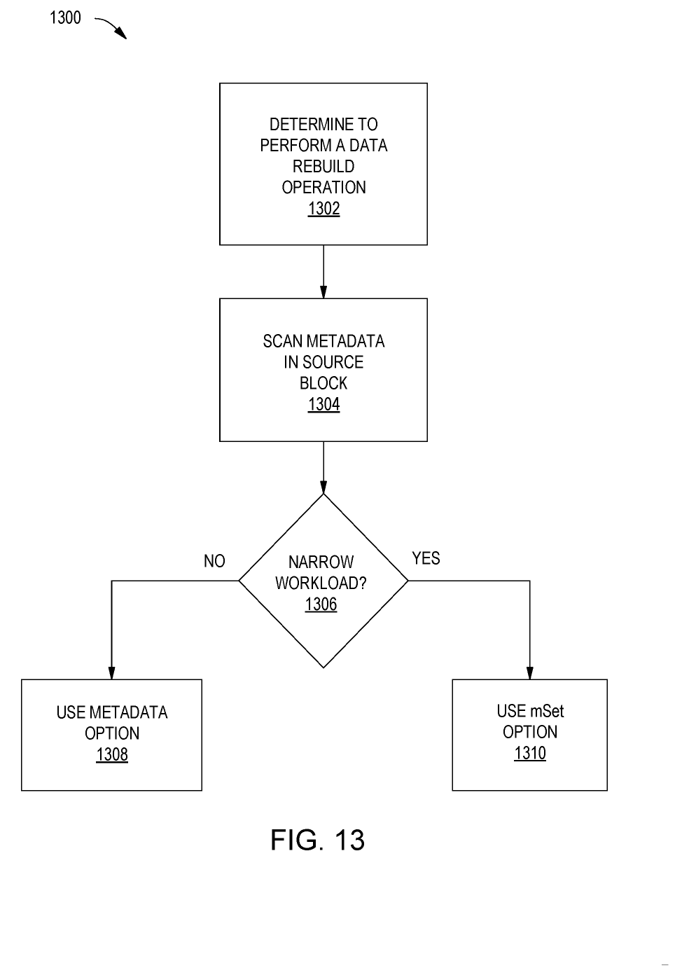

FIG. 13 is a flowchart 1300 illustrating a data rebuild or relocation via metadata or mSet according to one embodiment. Initially, a determination is made to perform a data rebuild operation at block 1302. The controller then scans the metadata in the source block at block 1304 and determines whether there is a narrow workload or a wide workload at block 1306. If there is a wide workload, then the metadata option is chosen at block 1308, but if there is a narrow workload, then the mSet option is chosen at block 1310.

By using a metadata option or an mSet option for data relocation, the amount of mSet loadings will be reduced and the next sequential reads will be more efficient.

In one embodiment, a data storage device comprises: a memory device; and a controller coupled to the memory device, wherein the controller is configured to: scan metadata in a source block for logical block addresses (LBAs) that belong to a same mSet; and copy data corresponding to the LBAs that belong to the same mSet from the source block to a destination block. The controller is configured to determine whether any LBAs are found in the source block. The controller is configured to release the source block. The controller is configured to determine whether there are additional mSets to relocate. The controller is configured to ignore obsolete LBAs. The controller is configured to ignore LBAs not belonging to the same mSet. The copying comprises move the data to a temporary storage location and then writing the data in the destination block. The temporary storage location is random access memory (RAM) and is separate and distinct from the memory device. The data is placed in the destination block in sequential order. The data is placed in the destination block out of sequential order.

In another embodiment, a data storage device comprises: a memory device; and a controller coupled to the memory device, wherein the controller is configured to: scan mSets for jumbo block addresses (JBAs) or flash management units (FMUs) that belong to a source block; and copy data for matching JBAs or FMUs to a destination block. Each FMU header in a scanned buffer of the source block is associated with an mSet and wherein the controller is configured to perform the scanning to check for valid FMUs that belong to the same source block. The copying comprises copying valid JBAs. The mSets are loaded into a dedicated storage location only one time per source block. The controller is configured to sort the FMUs or JBAs so that the data is in sequential order in the destination block. The controller is configured to validate the FMUs. The controller is configured to determine whether the source block contains a wide or narrow workload.

In another embodiment, a data storage device comprises: means to store data; and a controller coupled to the means to store data, wherein the controller is configured to: determine to perform a data rebuild operation; scan metadata in a source block; determine whether a workload is a narrow workload or a wide workload; and copy valid data from the source block to a destination block. The controller is configured to scan the metadata looking for logical block addresses (LBAs) that belong to the same mSet and copy data for LBAs that belong to the same mSet to the destination block one after another. The controller is configured to: bring an mSet related to a logical block address (LBA) found in the metadata to a designated storage location; scan the mSet for jumbo block addresses (JBAs) that belong to the source block; and copy data for the JBAs to the destination block one after another.

While the foregoing is directed to embodiments of the present disclosure, other and further embodiments of the disclosure may be devised without departing from the basic scope thereof, and the scope thereof is determined by the claims that follow.

What is claimed is:

1. A data storage device, comprising:
a memory device; and
a controller coupled to the memory device, wherein the controller is configured to:
scan metadata in a source block for logical block addresses (LBAs) that belong to a same mSet; and
copy data corresponding to the LBAs that belong to the same mSet from the source block to a destination block.

2. The data storage device of claim 1, wherein the controller is configured to determine whether any LBAs are found in the source block.

3. The data storage device of claim 1, wherein the controller is configured to release the source block.

4. The data storage device of claim 1, wherein the controller is configured to determine whether there are additional mSets to relocate.

5. The data storage device of claim 1, wherein the controller is configured to ignore obsolete LBAs.

6. The data storage device of claim 1, wherein the controller is configured to ignore LBAs not belonging to the same mSet.

7. The data storage device of claim 1, wherein the copying comprises move the data to a temporary storage location and then writing the data in the destination block.

8. The data storage device of claim 7, wherein the temporary storage location is random access memory (RAM) and is separate and distinct from the memory device.

9. The data storage device of claim 1, wherein the data is placed in the destination block in sequential order.

10. The data storage device of claim 1, wherein the data is placed in the destination block out of sequential order.

11. A data storage device, comprising:
a memory device; and
a controller coupled to the memory device, wherein the controller is configured to:
scan mSets for jumbo block addresses (JBAs) or flash management units (FMUs) that belong to a source block; and
copy data for matching JBAs or FMUs to a destination block.

12. The data storage device of claim 11, wherein each FMU header in a scanned buffer of the source block is associated with an mSet and wherein the controller is configured to perform the scanning to check for valid FMUs that belong to the same source block.

13. The data storage device of claim 11, wherein the copying comprises copying valid JBAs.

14. The data storage device of claim 11, wherein the mSets are loaded into a dedicated storage location only one time per source block.

15. The data storage device of claim 11, wherein the controller is configured to sort the FMUs or JBAs so that the data is in sequential order in the destination block.

16. The data storage device of claim 11, wherein the controller is configured to validate the FMUs.

17. The data storage device of claim 11, wherein the controller is configured to determine whether the source block contains a wide or narrow workload.

18. A data storage device, comprising:
means to store data; and
a controller coupled to the means to store data, wherein the controller is configured to:
determine to perform a data rebuild operation;
scan metadata in a source block;
determine whether a workload is a narrow workload or a wide workload; and
copy valid data from the source block to a destination block.

19. The data storage device of claim 18, wherein the controller is configured to scan the metadata looking for logical block addresses (LBAs) that belong to the same mSet and copy data for LBAs that belong to the same mSet to the destination block one after another.

20. The data storage device of claim 18, wherein the controller is configured to:
bring an mSet related to a logical block address (LBA) found in the metadata to a designated storage location;
scan the mSet for jumbo block addresses (JBAs) that belong to the source block; and
copy data for the JBAs to the destination block one after another.
